(19) United States
(12) Patent Application Publication
(10) Pub. No.: US 2009/0158997 A1
(43) Pub. Date: Jun. 25, 2009

(54) Coating Machine for Confectioneries Including a Bottom Coating Apparatus

(75) Inventor: Thomas Ellinghoven, Herford (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SOLLICH KG, Bad Salzuflen (DE)

(21) Appl. No.: 12/339,446

(22) Filed: Dec. 19, 2008

(30) Foreign Application Priority Data
Dec. 22, 2007 (DE) 102007062468.0

(51) Int. Cl. A23G 3/20

(52) U.S. Cl. 118/13

(57) ABSTRACT

A coating machine (1) for coating confectioneries (5) with a liquid coating mass (7) includes a grid belt (3) being driven in a working direction (4) for transporting the confectioneries (5). A bottom coating apparatus (2) includes a container-shaped box (6) serving to contain liquid coating mass (7). A bottom roller (10) is arranged below the grid belt (3). The bottom roller (10) serves to convey the coating mass (7) from the box (6) in an upward direction. A detaching element (15) is in sliding contact with the bottom roller (10) to remove coating mass (7) from the bottom roller (10) to form a bottom coating mass. A bottom coating mass forming element (16) is designed as a separate element in addition to the detaching element (15). The element (16) is arranged below the grid belt (3) in a way that it redirects and deforms the bottom coating mass such that a part thereof moves through the grid belt (3) in an upward direction to form an upper part of the bottom coating mass (22). The element (16) has a forming surface (17) for contacting the coating mass in a way to determine the cross-sectional profile (23) of the upper part of the bottom coating mass (22). The element (16) is replaceable and/or adjustable with respect to the detaching element (15) to determine the cross-sectional profile (23) of the upper part of the bottom coating mass (22).

### CROSS REFERENCE TO RELATED APPLICATIONS

This application claims priority to co-pending German Patent Application No. DE 10 2007 062 468.0 entitled “Überziehmaschine für Süβwarenstücke mit einer Bodenwallstation”, filed Dec. 22, 2007.

### FIELD OF THE INVENTION

The present invention generally relates to a coating machine for coating confectioneries with a liquid coating mass. The coating machine includes a grid belt being driven in a working direction and serving to transport the confectioneries being places thereon. The coating machine also includes a bottom coating apparatus.

Especially, the coating machine is designed for coating bars, cookies and other confectioneries with a chocolate mass. The coating mass may also be a different fat containing mass, for example a mass including caramel or fudge. The coating mass may be applied to the entire surface of the confectioneries or only to a part thereof including the bottom.

### BACKGROUND OF THE INVENTION

A coating machine for coating confectioneries with liquid masses, especially chocolate, is known from German Patent No. DE 468 053. The known coating machine includes a grid belt being driven in a working direction and a bottom coating apparatus including a container-shaped box serving to contain liquid coating mass. A driven bottom roller extends into the box, and it serves to convey the liquid mass in an upward direction. The bottom roller is located below the grid belt. The apparatus includes a pre-stripper being arranged with respect to the surface of the bottom roller to form a gap with which the thickness of the coating mass being located on the bottom roller is adjusted. The pre-stripper also strips off surplus mass while the mass serving to form the bottom coating mass remains on the surface of the bottom roller. A stationary element fulfilling the functions of a bottom coating mass carrier and of a detaching element for the mass being transported by the bottom roller is arranged with respect to the bottom roller in a stationary way. The detaching part of this element detaches the mass serving to form the bottom coating mass from the circumference of the bottom roller, and it guides this mass in the direction towards a gap. The gap is formed between the detaching part of the stationary element and a second adjustable metal sheet. The detaching part and the metal sheet form a nozzle-like cross-section in the gap through which the detached mass is pressed while it simultaneously protrudes through the grid belt from below. In this way, one attains an upper part of the bottom coating mass. The height of the formed upper part of the bottom coating mass on the bottom coating mass carrier is determined by adjusting the metal sheet of the nozzle. It is possible to arrange an additional conveyor belt the transporting velocity of which is controllable to allow for fine adjustment of the height of the upper part of the coating mass on the part of the element fulfilling the function of the bottom coating mass carrier. The known apparatus does not include a bottom coating mass forming element being designed as a separate element in a way to be replaceable and/or adjustable with respect to the detaching element and with which the shape of the upper part of the bottom coating mass with respect to its cross-sectional profile in the working direction can be influenced.

A coating machine including a bottom coating apparatus for confectioneries including a grid belt being driven in the working direction is known from German Patent No. DE 42 12 427 C1. The bottom coating apparatus includes a container-shaped box serving to contain a liquid coating mass, especially chocolate. The liquid coating mass is conveyed into the box by a pump. An approximately constant level of coating mass contained in the box is adjusted, for example by an overflow being designed as elongated slots located in the side wall of the box. A driven bottom roller serves as the conveying element for conveying the coating mass from the box in an upward direction. The bottom roller is arranged below the grid belt, and it protrudes below the level of the coating mass contained in the box. A detaching element is arranged with respect to the circumference of the bottom roller such that it contacts the bottom roller. The detaching element functions as a doctor blade to substantially detach all surplus coating mass from the bottom roller to form a bottom coating mass. The bottom roller is arranged below the grid belt in a spaced apart manner. The bottom roller is driven to rotate in an opposite direction with respect to the working direction. The detaching element is located downstream of the bottom roller, meaning at a place where the surface of the bottom roller is already moved back in a downward direction. The detaching element is supported in supports to be capable of using gravity for the sliding contact. In addition, springs serving to increase the contact force may be arranged. The supports also serve to be capable of easily removing and cleaning the detaching element. The height of the upper part of the bottom coating mass which substantially determines the height of the coating being located at the side walls of the confectioneries is controlled by a variation of the number of rotations of the drive of the bottom roller. The detaching element may have a wedge-shaped cross-section. A bottom coating mass is formed, the coating mass being pressed through the grid belt in an upward direction by the circumference of the grid belt due to the proximity to the detaching element and the accumulating effect resulting therefrom. The detaching element may also have a rectangular cross-section such that the bottom coating mass has a slightly different shape at the place where it is formed. The effect of the conveyed coating mass being pressed through the grid belt is increased at the place where it is formed. Influencing the shape of the bottom coating mass is substantially limited to the place where it is formed at the detaching element, meaning to the lower part of the bottom coating mass being located below the grid belt. The height of the upper part of the bottom coating mass being located above the grid belt is not substantially influenced by the variation of the cross-section of the detaching element. The height of the upper part of the bottom coating mass substantially depends on the number of rotations and thus on the surface velocity of the bottom roller. The length of the upper part of the bottom coating mass is influenced by a bottom coating mass carrier being arranged below the grid belt. This carrier may be designed to be adjustable.

A unit for regulation of the bottom coating mass in a coating machine is known from German Patent No. DE 35 04 174 C2. The bottom coating mass is formed by a conveying roller being located below the grid belt in combination with a stripper being located in a spaced apart manner with respect to the conveying belt such that a gap is formed. In this way, the thickness of the coating mass being located on the conveying belt is limited. The stripper removes surplus mass from the conveying roller, meaning mass which is not used to form the bottom coating mass. The known coating machine does not include a detaching element serving to remove coating mass being transported by the conveying belt in an upper direction to form a bottom coating mass. The functional elements are designed to be adjustable with respect to their position with respect to the conveying roller to adjust the amount of conveyed mass for forming the bottom coating mass. The amount of conveyed mass and thus the thickness of the bottom coating mass on the bottom coating mass sheet are adjusted with these functional elements. Furthermore, a bottom coating mass sheet fulfilling the function of a bottom coating mass carrier is arranged. The bottom coating mass sheet supports the bottom coating mass from below and thus prevents its movement through the grid belt where the bottom coating sheet is arranged. Depending on the adjusted amount of coating mass to be conveyed, the thickness of the bottom coating mass being located on the bottom coating mass sheet varies.

Furthermore, it is known in the prior art to arrange a pre-stripper at the side of the bottom roller which is moved in an upward direction during its rotational movement. In contrast to the detaching element described herein, such a pre-stripper is not located with respect to the surface of the bottom roller in a way to contact the bottom roller, but it is arranged in a spaced apart manner thereto such that a passage gap for passage of coating mass being conveyed by the bottom roller in an upward direction is formed.

### SUMMARY OF THE INVENTION

The present invention generally relates to a coating machine for coating confectioneries including a bottom coating apparatus.

More particularly, the present invention relates to a coating machine for coating confectioneries with a liquid coating mass. A grid belt is designed and arranged to be driven in a working direction and to transport confectioneries being located on the grid belt in the working direction. A bottom coating apparatus includes a container-shaped box serving to contain liquid coating mass. A bottom roller having a circumference is arranged below the grid belt. The bottom roller is designed and arranged to convey the coating mass from the box in an upward direction. A detaching element is designed and arranged with respect to the circumference of the bottom roller to be in sliding contact therewith to remove coating mass from the circumference of the bottom roller to form a bottom coating mass. A bottom coating mass forming element is designed as a separate element in addition to the detaching element. The bottom coating mass forming element is arranged below the grid belt in a way that it redirects and deforms the bottom coating mass such that a part of the bottom coating mass moves through the grid belt in an upward direction to form an upper part of the bottom coating mass. The bottom coating mass forming element has a forming surface being designed and arranged to contact the bottom coating mass in a way to determine the cross-sectional profile of the upper part of the bottom coating mass. The bottom coating mass forming element is designed to be changeable with respect to the detaching element to determine the cross-sectional profile of the upper part of the bottom coating mass.

The feature of the bottom coating mass forming element being changeable with respect to the detaching element is to be understood as including an adjustment of the forming element as well as a replacement of the forming element. The upper part of the bottom coating mass is to be understood as the part of the bottom coating mass which has passed through the grid belt in an upward direction and which is now located above the grid belt. This upper part forms some sort of “wave” on the grid belt.

With the novel coating machine including a bottom coating apparatus, it is possible to influence and determine, respectively, the cross-sectional profile of the upper bottom coating mass in the working direction of the machine in a better and more exact way.

It is a conclusion of the present invention that not only the height and the length of the upper part of the bottom coating mass is of importance for attaining a good coating result at the confectioneries. The profile of the upper part of the bottom coating mass in the working direction as it is attained in a vertical section in the working direction is of decisive importance. A rising portion of the upper part of the bottom coating mass may be differentiated from a center portion more or less having the same height and a descending portion of the upper part of the bottom coating mass. The rising portion of the upper part of the bottom coating mass is to be understood as the part of the upper part of the bottom coating mass beginning at the passage location of the coating mass through the grid belt and extending in the working direction until the maximum height of the upper part of the bottom coating mass is reached. The rising portion may be steep or smooth to a higher degree or to a lower degree, and it may be coordinated with the maximum height of the upper part of the bottom coating mass, meaning especially from the amount of coating mass being delivered within each time interval which substantially depends on the number of rotations of the bottom roller.

The present invention is directed to confectioneries the bottom of which is to be covered with a bottom coating mass. The bottom coating mass is pressed through the openings of the grid belt from below in an upper direction, and it reaches the bottom and parts of the side walls of the confectioneries. The bottom coating apparatus may be a separate apparatus, or it may be a bottom coating station in a coating machine including a curtain through or in a decorating machine, for example.

The novel bottom coating apparatus includes a detaching element being arranged under sliding contact with respect to the circumference of the bottom roller and serving to remove the coating mass being conveyed by the bottom roller from the box to form and dam the bottom coating mass. Such a detaching element is to be differentiated from a pre-stripper being located in a spaced apart manner with respect to the surface of the bottom roller and insofar forming a passage gap for coating mass being upwardly conveyed by the bottom roller. Such a pre-stripper limits the amount of the coating mass being supplied at the detaching element by the bottom roller.

A bottom coating mass forming element is designed as a separate element in addition to the detaching element. The bottom coating mass forming element is designed and arranged to redirect and deform the coating mass being detached from the bottom roller such that a part of the bottom coating mass after having passed through the grid belt forms the upper part of the bottom coating mass. The bottom coating mass forming element is located close to the detaching element and above it such that it is arranged between the detaching element and the bottom side of the grid belt. The bottom coating mass forming element has a forming surface having a design such that it strongly influences the shape of the cross-sectional profile of substantial portions of the upper part of the bottom coating mass, especially with respect to its rising portion. The bottom coating mass forming element is designed to be replaceable and/or adjustable with respect to the detaching element while the detaching element in the operating position is designed to be stationary and to contact the circumference of the bottom roller. The bottom coating mass forming element may be adjusted with respect to the detaching element at any time. It is also possible to have a plurality of bottom mass forming elements having different forming surfaces and to design these to be replaceable such that a desired cross-sectional profile of the upper part of the bottom coating mass in the working direction can be reproducibly adjusted for special applications. The bottom coating mass forming element is also associated with the bottom roller. This means that the shape of the cross-sectional profile of the upper part of the bottom coating mass in the working direction is attained by the number of rotations and the diameter of the bottom roller, on the one hand, and by the respective adjustment of the bottom coating mass forming element, on the other hand.

With the novel bottom coating mass forming element, it is possible to produce a long flat cross-sectional profile of the upper part of the bottom coating mass, for example, to make sure that there is a comparatively long contact time of the confectioneries with the upper part of the bottom coating mass. In this way, it is especially possible to attain a closed coating of the bottom even at confectioneries having an open-pored or craggy bottom. The bottom is substantially bubble-free since the bottom coating mass forming element prevents bubbles to be formed. On the other hand, it is also possible, for example when masking confectioneries having a greater height, to produce a very high bottom coating mass with a smooth rising portion. Such a long and smoothly inclined rising portion and a short and steep descending portion, respectively, may be chosen and adjusted independently from the maximum height of the upper part of the bottom coating mass. In this way, the quality of the bottom coating of the confectioneries is substantially improved.

The bottom coating mass forming element includes a forming surface contacting the coating mass being detached by the detaching element, the forming surface serving to determine the cross-sectional profile of the upper part of the bottom coating mass. The forming surface may be designed in a way that the entire cross-sectional profile of the upper part of the bottom coating mass being located above the grid belt or at least its rising portion is determined as seen in a vertical section in the working direction. Especially, this determination is coordinated with the number of rotations and the diameter of the bottom roller. It is to be understood that influencing the cross-sectional profile of the upper part of the bottom coating mass by the bottom coating mass forming element primarily relates to the rising portion of the upper part of the bottom coating mass. An additional bottom coating mass carrier may be used to determine the length of the upper part of the bottom coating mass. The combination of these three elements determines the entire course of the cross-sectional profile of the upper part of the bottom coating mass from its beginning to its end. The bottom coating mass forming element may also be associated with a pre-stripper serving to limit the amount of coating mass being upwardly transported by the bottom roller by using a gap. In this way, the shape of the cross-sectional profile of the upper part of the bottom coating mass is at least indirectly influenced. The bottom roller may be operated to rotate in the working direction of the grid belt or in the opposite direction. The bottom roller may also be designed such that its vertical position is adjustable to vary the distance with respect to the bottom side of the grid belt.

For example, the forming surface of the bottom coating mass forming element may be designed to be inclined, bent, or curved. Especially, the forming surface may have a shape similar to a ploughshare.

The bottom coating mass forming element and its forming surface, respectively, may be designed to be adjustable with respect to the detaching element and to the surface of the bottom roller in a translational and/or rotatory way. In all cases, this adjustment influences the cross-sectional profile of the upper part of the bottom coating mass. In coordination therewith, the detaching element may also be designed and arranged to be pivotable in a way that it can be pivoted about the axis of its free end serving for sliding contact to the bottom roller.

The bottom coating mass forming element is arranged above the detaching element and below the grid belt. It is located close to the detaching element, and it is preferred that there is no gap with respect to the detaching element to prevent coating mass from passing through such a gap. As a result, all coating mass being supplied by the bottom roller may be used as bottom coating mass.

The bottom coating mass forming element may also include and form, respectively, a supporting surface for the grid belt to exactly determine the passage location for the coating mass through the grid belt in an upward direction and to thus define the beginning of the rising portion of the upper part of the bottom coating mass. In this way, the bottom coating mass forming element also prevents the bottom coating mass from flipping over when it passes through the grid belt in an upward direction.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a side view of a first exemplary embodiment of the novel bottom coating apparatus.

FIG. 2 is a cross-sectional view of a second exemplary embodiment of the novel bottom coating apparatus illustrating the cross-sectional profile of the upper part of the bottom coating mass having a short rising portion.

FIG. 3 is another cross-sectional view of the second exemplary embodiment of the novel bottom coating apparatus illustrating the cross-sectional profile of the upper part of the bottom coating mass having a smooth long rising portion.

FIG. 4 is another cross-sectional view of the second exemplary embodiment of the novel bottom coating apparatus, and it emphasizes the shape of the cross-sectional profile of the upper part of the bottom coating mass having a steep rising portion as seen in the working direction during a great number of rotations of the bottom roller.

FIG. 5 is another cross-sectional view of the second exemplary embodiment of the novel bottom coating apparatus, and it emphasizes the shape of the cross-sectional profile of the upper part of the bottom coating mass having a smooth rising portion as seen in the working direction during a great number of rotations of the bottom roller.

FIG. 6 is another cross-sectional view of the second exemplary embodiment of the novel bottom coating apparatus, and it emphasizes the shape of the cross-sectional profile of the upper part of the bottom coating mass having a steep rising portion as seen in the working direction during a comparatively low number of rotations of the bottom roller.

FIG. 7 is another cross-sectional view of the second exemplary embodiment of the novel bottom coating apparatus, and it emphasizes the shape of the cross-sectional profile of the upper part of the bottom coating mass having a smooth rising portion as seen in the working direction during a comparatively low number of rotations of the bottom roller.

### DETAILED DESCRIPTION

Referring now in greater detail to the drawings, FIG. 1 illustrates a first exemplary embodiment of the novel coating machine 1 including the novel bottom coating apparatus 2. A grid belt 3 is rotatingly driven in an endless way according to the working direction 4 being illustrated by the arrow. Confectioneries 5 are located on the grid belt 3. Preferably, the confectioneries are arranged in rows side by side and one after the other in a spaced apart manner. A container-shaped box 6 is located below the grid belt 3. Only the wall portions of the box 6 are illustrated. It is to be understood that a coating mass 7 is located in the box 6, and it is continuously fed to the box 6 by a feeding pump (not illustrated), respectively. The box 6 may include a feeding tube 8 by which the coating mass 7 is continuously introduced into the box 6. The feeding tube 8 may be arranged at a rear transverse wall of the box 6. The feeding tube 8 includes one or more openings by which the liquid coating mass 7 is introduced into the container-shaped box 6 by the pump (not illustrated). Circulation and addition of the coating mass 7 are controlled in a way that one attains a mass level 9 being approximately constant.

A bottom roller 10 (which may also be called a dipping roller or a dunking roller) is associated with the box 6 and the mass level 9, respectively. The bottom roller 10 is rotatingly supported in a bearing 11, and it is connected to a drive to be rotatingly driven. The bottom roller 10 is driven in the direction of arrow 12 such that its upper surface is moved in the working direction 4 of the grid belt 3. The bottom roller 10 may be arranged in the bearing 11 to be adjustable in height to allow for adjustment of the distance with respect to the bottom side of the grid belt 3.

A pre-stripper 14 may be associated with the bottom roller 10, the pre-stripper 14 being arranged with respect to the surface of the bottom roller 10 at a distance such that a gap is formed. The size of the gap may be designed to be adjustable by respective adjustment of the pre-stripper 14 in coordination with the vertical position of the bottom roller 10. Due to the existence of this gap, the amount and volume, respectively, of the coating mass 7 being transported by the bottom roller 10 in an upward direction is limited and evened out over the working width. However, it is also possible not to arrange the pre-stripper 14.

A detaching element 15 is located at the other side of the bottom roller 10 in a region in which the surface of the bottom roller 10 already is moved in a downward direction. The detaching element 15 is in sliding contact to the surface of the bottom roller 10, and it serves to more or less detach the entire coating mass 7 from the bottom roller 10. FIG. 1 illustrates the inoperative position of the coating machine 1, and it does not illustrate the bottom coating mass, respectively, to simplify describing of the design and arrangement of the components of the coating machine 1 and of the bottom coating apparatus 2, respectively. The detaching element 15 may be arranged to be horizontal, as illustrated, and located in supporting elements (not illustrated) in a way to contact the surface of the bottom roller 10. The detaching element 15 may also have a shape similar to a knife to attain line contact in the detachment location.

A bottom coating mass forming element 16 is arranged close to the detaching element 15 below the lower side of the grid belt 3. In the illustrated example, the bottom coating mass forming element 16 includes a straight and declined forming surface 17. The element 16 is designed to be adjustable in a longitudinal direction according to double arrow 18 such that it is adjustable with respect to the stationary detaching element 15. The detaching element 15 detaches and removes the coating mass 7 being conveyed by the bottom roller 10, and it initially dams the coating mass 7. The bottom coating mass forming element 16 forms the coating mass 7 to attain the desired shape which results in an upper part of the bottom coating mass (not illustrated in FIG. 1) being produced. The upper part of the bottom coating mass is to be understood as the part of the bottom coating mass passing through the grid belt 3 in an upward direction and which is located above the grid belt 3. The bottom coating mass is also sometimes called the “bottom wall”, and the upper part of the bottom coating mass may also be called the “bottom wave”.

A bottom coating mass carrier 19 may be arranged downstream of the bottom coating mass forming element 16 as seen in the working direction 4. The carrier 19 may be designed and arranged to be adjustable according to double arrow 20. The carrier 19 may also be designed in a way that its length can be changed.

FIGS. 2 and 3 illustrate another exemplary embodiment of the novel bottom coating apparatus 2. In this case, the bottom roller 10 is driven according to arrow 21 in a direction opposite to the working direction 4 of the grid belt 3. A pre-stripper 14 and a bottom coating mass carrier 19 may be associated with the bottom roller 10. In this embodiment, these elements 14 and 19 are designed as one piece such that the end of the bottom coating mass carrier 19 facing the bottom roller 10 at the same time forms the edge for forming the gap of the pre-stripper 14.

It is to be easily seen from a comparison of FIGS. 2 and 3 that the detaching element 15 is designed to be stationary, whereas the bottom coating mass forming element 16 with its forming surface 17 is designed to be adjustable in a plane parallel to the plane of the grid belt 3 such that the distance of the bottom coating mass forming element 16 with respect to the surface of the bottom roller 10 is changeable.

FIGS. 2 and 3 also illustrate an upper part of the bottom coating mass 22. The upper part of the bottom coating mass 22 is to be understood as the part of the coating mass 7 which has passed the grid belt 3 in an upward direction and which is located above the surface of the grid belt 3. The confectioneries 5 are directly contacted by the upper part of the bottom coating mass 22 as they are transported through the upper part 22 while they are placed on the grid belt 3.

A comparison of FIGS. 2 and 3 also clarifies different shapes of a cross-sectional profile 23 of the upper part 22 as seen in a vertical sectional view in the working direction 4. It is differentiated herein between a rising portion 24, a center portion 25 and a descending portion 26 at the end of the carrier 19. As illustrated in FIG. 2, the rising portion 24 may be designed to be comparatively steep such that it only has a comparatively short length. This effect is attained when the bottom coating mass forming element 16 with its forming surface 17 is arranged to be located comparatively close to the surface of the bottom roller 10. A comparatively long rising portion 24 being extended and more smooth is attained when the bottom coating mass forming element 16 has a comparatively great distance to the surface of the bottom roller 10, meaning when it is arranged to be located comparatively far away in a direction against the working direction (see FIG. 3). The maximum height 27 of the upper part of the bottom coating mass 22 is located in the respective center portion 25. The maximum height 27 of the upper part 22 strongly depends on the number of rotations of the bottom roller 10 as well as on the arrangement of the pre-stripper 14 as well as on the design of the rising portion 24. The maximum height 27 of the cross-sectional profile 23 of the upper part of the bottom coating mass 22 may be attained earlier or later as seen in the working direction 4. The center portion 25 of the upper part of the bottom coating mass 22 may be extended and shortened, respectively, by choosing the arrangement of the bottom coating mass carrier 19. In coordination with the bottom coating mass forming element 16, the length of the cross-sectional profile 23 may be chosen and determined in this way. The maximum height 23 is determined by the end of the bottom coating mass carrier 19 only being schematically illustrated.

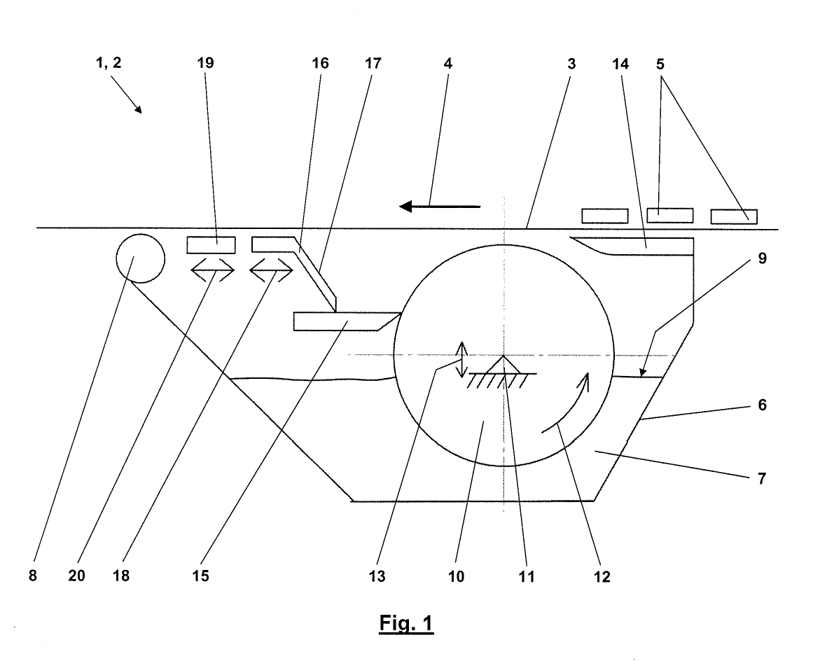

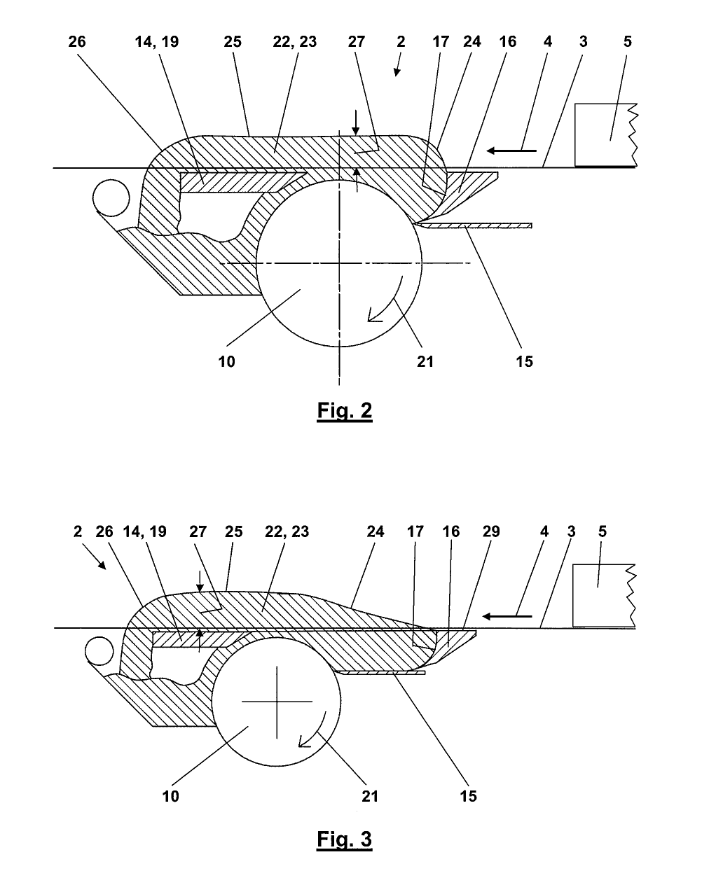

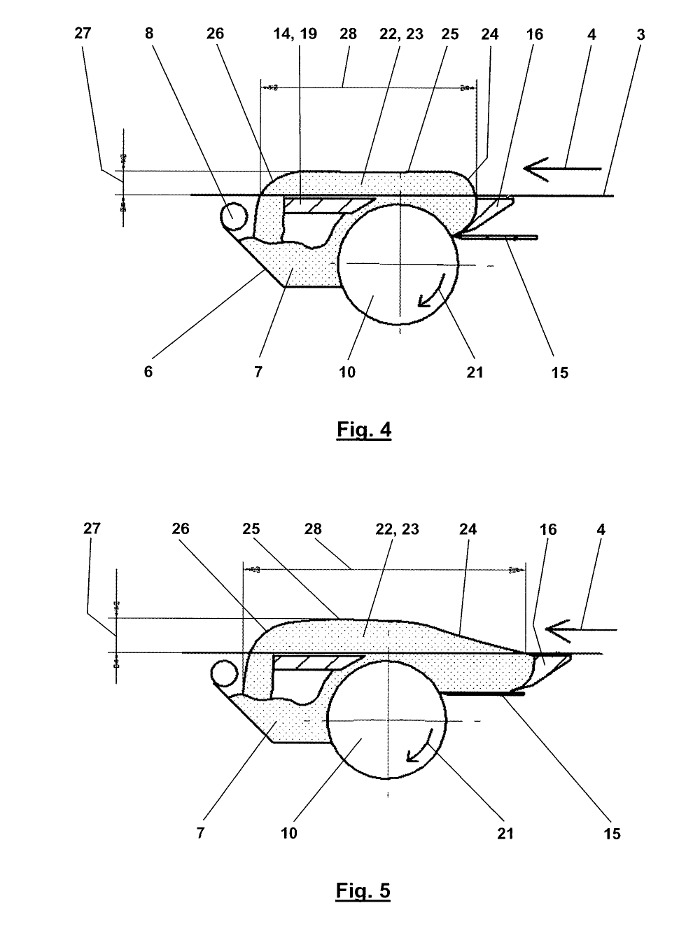

FIGS. 4 to 7 also illustrate the length of the cross-sectional profile 23 of the upper part of the bottom coating mass 22. By a comparison of FIGS. 4 to 7, one realizes how the cross-sectional profile 23 of the upper part of the bottom coating mass 22 can be varied. The upper part of the bottom coating mass 22 finally determines the desired work result, meaning the arrangement of a coating on the bottom and the side walls of the confectioneries 5. In the illustrated way, the rising portion 24, the center portion 25 having the maximum height 27 and also partly the descending portion 26 of the cross-sectional profile 23 can be influenced.

FIG. 4 illustrates an exemplary shape of the cross-sectional profile 23 of the upper part of the bottom coating mass 22 using a combination of the arrangement of the bottom coating mass forming element 16 serving to attain a steep rising portion 24 and a comparatively great number of rotations of the bottom roller 10 resulting in a comparatively great amount and volume of coating mass 7 being conveyed in an upward direction.

FIG. 5 illustrates a position of the bottom coating mass forming element 16 serving to attain a smooth rising portion 24 of the cross-sectional profile 23 of the upper part of the bottom coating mass 22. The maximum height 27 located in the center portion 25 of the cross-sectional profile 23 is increased with respect to the one illustrated in FIG. 4. Such a cross-sectional profile 23 may be attained by a comparatively number of rotations of the bottom roller 10.

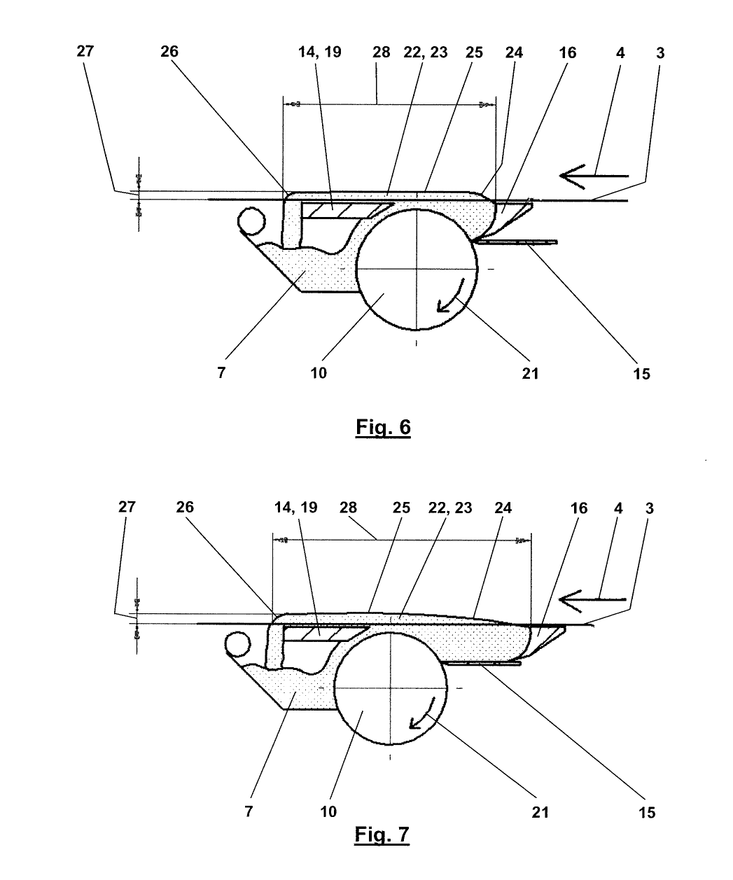

FIGS. 6 and 7 illustrate cross-sectional profiles 23 of the upper part of the bottom coating mass 22 during a comparatively low number of rotations of the bottom roller 10. This means that a comparatively small amount of coating mass 7 is transported and conveyed in an upward direction. In FIGS. 6 and 7, the bottom coating mass forming element 16 is located at a comparatively short distance with respect to the surface of the detaching element 15 to be located comparatively close to the surface of the bottom roller 10 such that one attains a steep rising portion 24 of the cross-sectional profile 23. FIG. 7 illustrates the relative position of the elements for attaining a smooth rising portion 24 having a comparatively small angle of inclination.

Although the above described exemplary drawings only illustrate bottom coating mass forming elements 16 being designed and arranged to be adjustable in a translational direction parallel to the plane of the grid belt 3, it is to be understood that different designs are also possible. The bottom coating mass forming element 16 may also be designed and arranged to be rotated for adjustment alternatively or in addition to the translational adjustment. By the rotational adjustment, the form surface 17 may be moved into a different relative position to especially influence the rising portion 24 of the cross-sectional profile 23 of the upper part of the bottom coating mass 22. It is also possible to have a plurality of bottom coating mass forming elements 16 having forming surfaces 17 of different shapes in a way to make it possible to replace the bottom coating mass forming elements 16. For example, this replacement may be used to more exactly adapt the cross-sectional profile 23 to the respective kind of confectioneries 5 to be coated. This especially applies to masking of such confectioneries 5 during which the coating mass 7 only is intended to reach the bottom and a part of the side walls of the confectioneries 5. In this case, it is especially desired that the upper edge of the coating is located at the same height for all side walls of the confectioneries 5, meaning that there is no increase or decrease in any direction. This desired effect may also be attained and improved, respectively, by adjustment of the bottom coating mass forming element 16. The length 28 of the cross-sectional profile 23 substantially determines the retention time and the contact time, respectively, between the upper part of the bottom coating mass 22 and the confectioneries 5. This is of special importance for attaining a closed bubble-free coated bottom of the confectioneries 5. The bottom coating mass forming element 16 may also form a supporting surface 29 (see FIG. 3) for the bottom side of the grid belt 3, the supporting surface 29 supporting the grid belt 3 such that the beginning of the rising portion 24 and its design at the grid belt 3 are determined in a reproducible manner.

Many variations and modifications may be made to the preferred embodiments of the invention without departing substantially from the spirit and principles of the invention. All such modifications and variations are intended to be included herein within the scope of the present invention, as defined by the following claims.

I claim:

1. A coating machine for coating confectioneries with a liquid coating mass, comprising:
a grid belt, said grid belt being designed and arranged to be driven in a working direction and to transport confectioneries being located on said grid belt in the working direction; and
a bottom coating apparatus, including:
a container-shaped box, said box serving to contain liquid coating mass,
a bottom roller having a circumference, said bottom roller being arranged below said grid belt, said bottom roller being designed and arranged to convey the coating mass from said box in an upward direction,
a detaching element, said detaching element being designed and arranged with respect to the circumference of said bottom roller to be in sliding contact therewith to remove coating mass from the circumference of said bottom roller to form a bottom coating mass,
a bottom coating mass forming element, said bottom coating mass forming element being designed as a separate element in addition to said detaching element, said bottom coating mass forming element being arranged below said grid belt in a way that it redirects and deforms the bottom coating mass such that a part of the bottom coating mass moves through said grid belt in an upward direction to form an upper part of the bottom coating mass,
said bottom coating mass forming element having a forming surface being designed and arranged to contact the bottom coating mass in a way to determine the cross-sectional profile of the upper part of the bottom coating mass, and
said bottom coating mass forming element being designed to be changeable with respect to the detaching element to determine the cross-sectional profile of the upper part of the bottom coating mass.

2. The coating machine of claim 1, wherein said bottom coating mass forming element is designed to be adjustable with respect to said detaching element to determine the cross-sectional profile of the upper part of the bottom coating mass.

3. The coating machine of claim 1, wherein said bottom coating mass forming element is designed to be replaceable with respect to said detaching element to determine the cross-sectional profile of the upper part of the bottom coating mass.

4. The coating machine of claim 1, wherein said forming surface of said bottom coating mass forming element is designed in a way that it at least determines a rising portion of the upper part of the bottom coating mass.

5. The coating machine of claim 1, wherein said forming surface of said bottom coating mass forming element is designed in a way that it determines the entire cross-sectional profile of the upper part of the bottom coating mass.

6. The coating machine of claim 1, wherein said forming surface is designed to be coordinated with a number of rotations and a diameter of said bottom roller.

7. The coating machine of claim 1, wherein said forming surface has a shape selected from the group consisting of an inclined shape, a bent shape and a curved shape.

8. The coating machine of claim 1, wherein said grid belt being driven in the working direction is moved within a plane, said bottom coating mass forming element being designed and arranged to be adjustable in a translational direction in the working direction and parallel to the plane of said grid belt.

9. The coating machine of claim 1, wherein said bottom coating mass forming element is designed and arranged to be pivotable about a rotational axis being located transverse to the working direction.

10. The coating machine of claim 1, wherein said detaching element is designed and arranged to be pivotable.

11. The coating machine of claim 1, wherein said bottom coating mass forming element is arranged above said detaching element.

12. The coating machine of claim 1, wherein said bottom coating mass forming element includes a supporting surface being designed and arranged to support said grid belt.

13. The coating machine of claim 1, wherein said bottom roller is driven to rotate in the same direction as the working direction.

14. The coating machine of claim 1, wherein said bottom roller is designed and arranged to be driven in a direction opposite to the working direction.

15. The coating machine of claim 1, further comprising a pre-stripper, said pre-stripper being arranged upstream of said detaching element as seen in the working direction.
